(19) United States
(12) Patent Application Publication
(10) Pub. No.: US 2024/0244687 A1
(43) Pub. Date: Jul. 18, 2024

(54) DATA TRANSMISSION METHOD AND APPARATUS THEREOF

(71) Applicant: MEDIATEK INC., Hsinchu City (TW)

(72) Inventors: Pochun FANG, Hsinchu City (TW); Ping-Jui HSIEH, Hsinchu City (TW)

(21) Appl. No.: 18/412,706

(22) Filed: Jan. 15, 2024

Related U.S. Application Data
(60) Provisional application No. 63/480,109, filed on Jan. 17, 2023.

(51) Int. Cl. H04W 76/15; H04L 1/20; H04W 28/02; H04W 28/04; H04W 28/08

(52) U.S. Cl. CPC H04W 76/15; H04L 1/203; H04W 28/0268; H04W 28/04; H04W 28/095

(57) ABSTRACT

A data transmission method is provided. The data transmission method may be applied to a multi-link operation between a first multi-link device (MLD) and a second MLD. The data transmission method may include the following steps. A processor of the first MLD may perform a spatial reuse transmission on at least one link between the first MLD and the second MLD. Then, the processor may dispatch data frames with the same traffic identifier (TID) for all links between the first MLD and the second MLD based on the physical layer (PHY) rates and packet error rates of all links between the first MLD and the second MLD. Then, the processor may transmit the data frames to the second MLD based on the dispatch result.

### CROSS REFERENCE TO RELATED APPLICATIONS

This application claims the benefits of U.S. Provisional Application No. 63/480,109 filed on Jan. 17, 2023, the entirety of which is incorporated by reference herein.

### BACKGROUND OF THE INVENTION

### Field of the Invention

The invention generally relates to wireless communication technology, and more particularly, to a data transmission technology for spatial reuse (SR) and multi-link transmission.

### Description of the Related Art

As demand for ubiquitous computing and networking has grown, various wireless technologies have been developed, including Wireless-Fidelity (Wi-Fi) which is a Wireless Local Area Network (WLAN) technology allowing mobile devices (such as smartphones, smart pads, laptop computers, portable multimedia players, embedded apparatuses, and the like) to obtain wireless services in a frequency band of 2.4 GHz, 5 GHz, 6 Gz or 60 GHz.

The Institute of Electrical and Electronics Engineers (IEEE) has developed and commercialized various technological standards since the initial WLAN technology is supported using frequencies of 2.4 GHz. For example, IEEE 802.11ac supports Multi-User (MU) transmission using spatial degrees of freedom via a MU-Multiple Input-Multiple-Output (MU-MIMO) scheme in a downlink (DL) direction from an Access Point (AP) to Stations (STAs). To improve performance and meet user demand for high-capacity and high-rate services, the IEEE 802.11ax has been proposed that uses both Orthogonal Frequency Division Multiple Access (OFDMA) and MU-MIMO in both DL and uplink (UL) directions. In addition to supporting frequency and spatial multiplexing from an AP to multiple STAs, transmissions from multiple STAs to the AP are also supported in IEEE 802.11ax.

In conventional technologies, the spatial reuse (SR) may be used in overlapping basic service set (OBSS) transmission. Specifically, when the OBSS traffic exists and the OBSS traffic does not have the same basic service set (BSS) color as the BSS color corresponding to the data which is currently transmitted on the same channel as the OBSS traffic, the AP may determine to perform the SR transmission to transmit the data on the channel.

In addition, in conventional technologies, a Wi-Fi multi-link operation (MLO) is provided. In the MLO, there are several links between two Wi-Fi multi-link devices (MLDs), including one access point (AP) MLD and one non-AP MLD (e.g., an STA), that occupy different radio-frequency (RF) bands. One Wi-Fi MLD can perform channel access (e.g., enhanced distributed channel access (EDCA)) on multiple wireless links independently. Specifically, these wireless links can operate independently to increase the overall throughput and to improve connection stability. Furthermore, the MLD link dispatch may be applied to the MLO.

However, in the conventional technologies, when the OBSS traffic exists, the MLD link dispatch will be suspended or paused. Therefore, the airtime may be wasted when most data is transmitted on a few links in the MLO.

Therefore, how to concern the special reuse and the MLD link dispatch at the same time is a topic that is worthy of discussion.

### BRIEF SUMMARY OF THE INVENTION

A data transmission method and an apparatus are provided to overcome the problems mentioned above.

An embodiment of the invention provides a data transmission method. The data transmission method may be applied to a multi-link operation between a first multi-link device (MLD) and a second MLD. The data transmission method may include the following steps. A processor of the first MLD may perform a spatial reuse transmission on at least one link between the first MLD and the second MLD. Then, the processor may dispatch data frames with the same traffic identifier (TID) for all links between the first MLD and the second MLD based on the physical layer (PHY) rates and packet error rates (PERs) of all links between the first MLD and the second MLD. Then, the processor may transmit the data frames to the second MLD based on the dispatch result.

An embodiment of the invention provides an access point (AP) for a multi-link operation between the AP and a station (STA). The AP may include a transceiver and a processor. The transceiver may perform wireless transmission and reception to and from the STA. The processor may be coupled to the transceiver. In addition, the processor may perform following operations. The processor may perform a spatial reuse transmission on at least one link between the AP and the STA. The processor may dispatch data frames with the same traffic identifier (TID) for all links between the AP and the STA based on the physical layer (PHY) rates and packet error rates (PERs) of all links between the AP and the STA. The processor may use the transceiver to transmit the data frames to the STA based on the dispatch result.

An embodiment of the invention provides a station (STA) for a multi-link operation between an access point (AP) and the STA. The STA may include a transceiver and a processor. The transceiver may be is configured to perform wireless transmission and reception to and from the AP. The processor may be coupled to the transceiver. In addition, the processor may perform following operations. The processor may receive, via the transceiver, data frames with the same traffic identifier (TID) from the AP based on the dispatch result determined by the AP. A spatial reuse transmission may be performed on at least one link between the AP and the STA by the AP. The data frames may be dispatched for all links between the AP and the STA based on the physical layer (PHY) rates and packet error rates (PERs) of all links between the AP and the STA by the AP to determine the dispatch result.

Other aspects and features of the invention will become apparent to those with ordinary skill in the art upon review of the following descriptions of specific embodiments of the data transmission method and AP and UE for multi-link operation.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating an AP according to an embodiment of the application.

FIG. 4 is a schematic diagram illustrating a data dispatch according to an embodiment of the invention.

FIG. 5 is a schematic diagram illustrating a data dispatch according to another embodiment of the invention.

FIG. 6 is a schematic diagram illustrating a data dispatch according to another embodiment of the invention.

FIG. 7 is a schematic diagram illustrating a data dispatch according to another embodiment of the invention.

FIG. 8 is a schematic diagram illustrating a data dispatch according to another embodiment of the invention.

FIG. 9 is a schematic diagram illustrating a data dispatch according to another embodiment of the invention.

FIG. 10 is a schematic diagram illustrating a data dispatch according to another embodiment of the invention.

FIG. 11 is a schematic diagram illustrating a data dispatch according to another embodiment of the invention.

FIG. 12 is a flow chart illustrating a data transmission method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

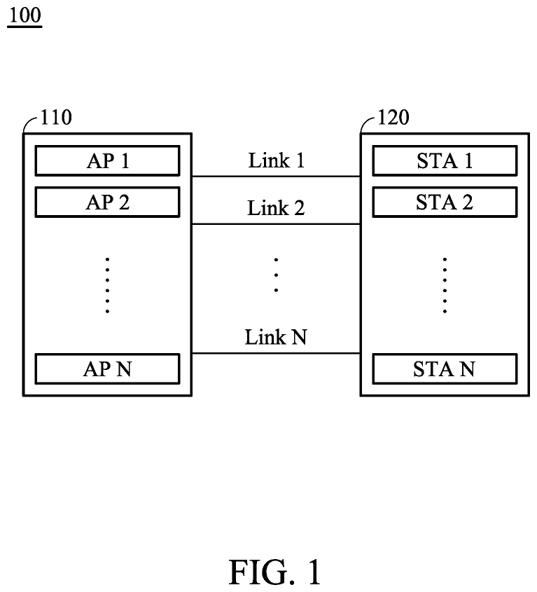

FIG. 1 is a block diagram of a wireless communication system 100 according to an embodiment of the application. As shown in FIG. 1, the wireless communication system 100 may include access point (AP) 110 and a communication apparatus 120. The AP 110 and the communication apparatus 120 may be the multi-link devices (MLDs), i.e., the AP 110 may be an AP MLD and the communication apparatus 120 may be a non-AP MLD. That is, the AP 110 may perform multi-link operation (MLO) with the communication apparatus 120 through multiple wireless links Link 1, Link 2 . . . Link N. Specifically, as shown in FIG. 1, the AP 110 may comprise a plurality of AP modules AP 1, AP 2, . . . , AP N, and the communication apparatus 120 may comprise a plurality of station (STA) modules (or non-AP modules) STA 1, STA 2, . . . , STA N. Each AP module and its corresponding STA module may correspond to a wireless link, e.g., AP 1 and STA 1 may correspond to Link 1. Each wireless link may correspond to a band, e.g., 2.4 GH, 5 GHz, or 6 GHz, but the invention should not be limited thereto. It should be noted that, in order to clarify the concept of the invention, FIG. 1 presents a simplified block diagram in which only the elements relevant to the invention are shown. However, the invention should not be limited to what is shown in FIG. 1.

The AP 110 may be an entity compatible with the Institute of Electrical and Electronics Engineers (IEEE) 802.11 standards to provide and manage the access to the wireless medium for the communication apparatus 120.

According to an embodiment of the invention, the AP 110 may be an Extremely High Throughput (EHT) AP which is compatible with the IEEE 802.11be standards. In another embodiment of the invention, the AP 110 may be an AP which is compatible with any IEEE 802.11 standards later than 802.11be.

According to the embodiments of the invention, the communication apparatus 120 may be may be user equipment (UE), a non-AP station (STA), a mobile phone (e.g., feature phone or smartphone), a panel Personal Computer (PC), a laptop computer, or any computing device, as long as it is compatible with the same IEEE 802.11 standards as the AP 110. The communication apparatus 120 may associate and communicate with the AP 110 to send or receive data in an uplink (UL) or downlink (DL) Multi-User-Physical layer Protocol Data Unit (MU-PPDU). The MU-PPDU may be a resource-unit Orthogonal Frequency Division Multiple Access (RU-OFDMA), a MU-Multiple Input-Multiple-Output (MU-MIMO) PPDU, or an aggregated PPDU.

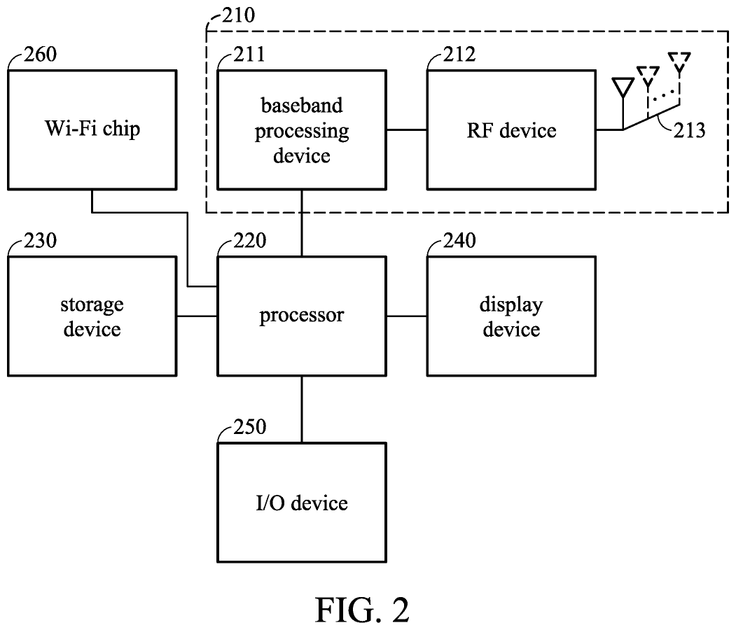

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250 and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the AP 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may be configured to perform the operations of Wi-Fi communications. In another embodiment of the invention, the wireless transceiver 210 may be also combined with the Wi-Fi chip 260 to form a Wi-Fi chip.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

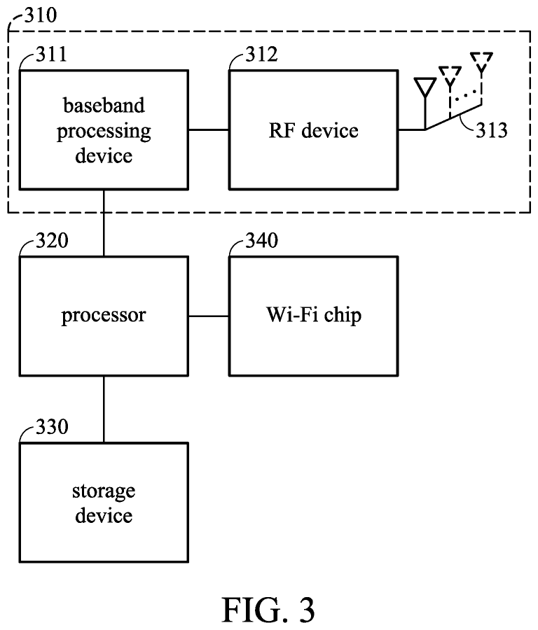

FIG. 3 is a block diagram illustrating an AP 300 according to an embodiment of the application. The AP 300 can be applied to the AP 110. As shown in FIG. 3, the AP 300 may comprise a wireless transceiver 310, a processor 320, a storage device 330, and a Wi-Fi chip 340.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

According to an embodiment of the invention, the Wi-Fi chip 340 may be configured to perform the operations of Wi-Fi communications. In another embodiment of the invention, the wireless transceiver 310 may be also combined with the Wi-Fi chip 340 to form a Wi-Fi chip.

It should be understood that the components described in the embodiment of FIG. 3 are for illustrative purposes only and are not intended to limit the scope of the application. For example, an AP may include more components, such as a display device for providing a display function, and/or an I/O device for providing an MMI for interaction with users.

According to an embodiment of the invention, when a first MLD (e.g., the AP 110) may transmit data frames (e.g., a plurality of medium access control (MAC) Protocol Data Units (MPDUs)) with the same traffic identifier (TID) to a second MLD (e.g., the communication apparatus 120) through multi-links, the first MLD may determine which link wins the contention first (i.e., the backoff counter of the link reaches 0 first). In an example, the link wining the contention may be an idle link. In another example, the link wining the contention may be the link with overlapping basic service set (OBSS). The OBSS traffic and the data frames transmitted on the link may use the same channel. When the OBSS traffic and the data frames transmitted on the link have different basic service set (BSS) colors, the first MLD may determine perform the spatial reuse (SR) to transmit the data frames on the link.

In addition, the first MLD may determine other links are idle links or the links with OBSS. Then, the first MLD may dispatch data frames (e.g., MPDUs) with the same TID for all links between the first MLD and the second MLD based on the physical layer (PHY) rates and packet error rates (PERs) of all links between the first MLD and the second MLD to achieve the closest frame exchange sequence (FES) airtime. Specifically, the data frames (e.g., MPDUs) with the same TID may be dispatched to different links between the first MLD and the second MLD to achieve the smallest time offset between the PPDU end time of different links or the block acknowledgement (BA) frames of different links. Accordingly, in the embodiments of the invention, the spatial reuse transmission will be further considered in the multi-link operations to achieve better bandwidth efficiency. FIGS. 5-8 are taken as examples to illustrate the embodiments of the invention below, but the invention should not be limited thereto. According to the embodiments of the invention, the data lengths of data frames dispatched for different links may be the same or different.

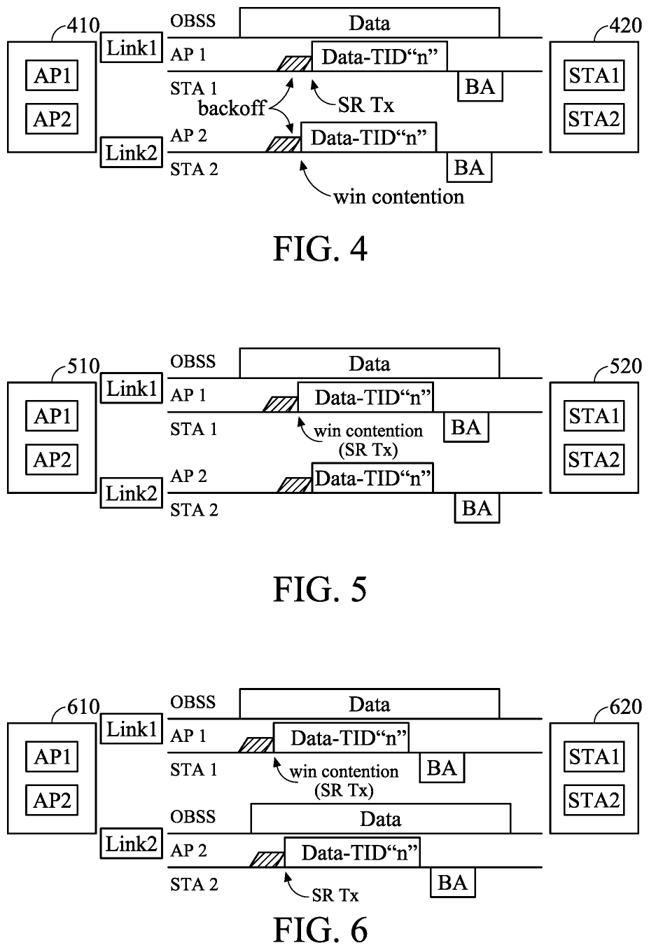

FIG. 4 is a schematic diagram illustrating a data dispatch according to an embodiment of the invention. The first MLD 410 and the second MLD 420 can be respectively applied to the AP 110 and the communication apparatus 120. As shown in FIG. 4, the first MLD 410 may comprise a first AP module AP 1 and a second AP module AP 2, and the second MLD 420 may comprise a first STA module STA 1 and a second STA module STA 2. The first AP module AP 1 and the first STA module STA 1 may correspond to Link 1, and the second AP module AP 2 and the second STA module STA 2 may correspond to Link 2. The Link 1 and the Link 2 may share the same block acknowledgement (BA) window. As shown in FIG. 4, the first MLD 410 may transmit data frames (e.g., MPDUs) with the same TID (e.g., TID “n”) to the second MLD 420 through the Link 1 and the Link 2. In the embodiment, the first MLD 410 determines that the Link 2 (idle link) wins the contention in the multi-link transmission, i.e., the backoff counter of the Link 2 reaches 0 first. Then, the first MLD 410 may determine or detect that the Link 1 maybe interfered by the OBSS traffic with the BSS color which is different from the data frames. Therefore, the first MLD 410 may determine to perform spatial reuse transmission on the Link 1. Then, the first MLD 410 may dispatch the data frames to the Link 1 and Link 2 based on the PHY rates and PERs of the Link 1 and Link 2 to achieve the closet FES airtime. That is, the partial data frames may be transmitted on the Link 1 and the remaining data frames may be transmitted on the Link 2 to achieve the closet FES airtime. For example, if the PHY rate (or SR rate) of the Link 1 is 1/2 PHY rate of the Link 2, the number of data frames (e.g., MPDUs) on the Link 1 and Link 2 may by 1:2 to achieve the same PPDU duration. After the dispatch, the first MLD 410 may transmit the data frames to the second MLD 420 according to the dispatch.

FIG. 5 is a schematic diagram illustrating a data dispatch according to another embodiment of the invention. The first MLD 510 and the second MLD 520 can be respectively applied to the AP 110 and the communication apparatus 120. As shown in FIG. 5, the first MLD 510 may comprise a first AP module AP 1 and a second AP module AP 2, and the second MLD 520 may comprise a first STA module STA 1 and a second STA module STA 2. The first AP module AP 1 and the first STA module STA 1 may correspond to Link 1, and the second AP module AP 2 and the second STA module STA 2 may correspond to Link 2. The Link 1 and the Link 2 may share the same BA window. As shown in FIG. 5, the first MLD 510 may transmit data frames (e.g., MPDUs) with the same TID (e.g., TID “n”) to the second MLD 520 through the Link 1 and the Link 2. In the embodiment, the first MLD 510 determines that the Link 1 wins the contention in the multi-link transmission, i.e., the backoff counter of the Link 1 reaches 0 first. Then, the first MLD 510 may determine or detect that the Link 1 maybe interfered by the OBSS traffic with the BSS color which is different from the data frames. Therefore, the first MLD 510 may determine to perform spatial reuse transmission on the Link 1. Then, the first MLD 510 may dispatch the data frames to the Link 1 and Link 2 based on the PHY rates and PERs of the Link 1 and Link 2 to achieve the closet FES airtime. That is, the partial data frames may be transmitted on the Link 1 and the remaining data frames may be transmitted on the Link 2 to achieve the closet FES airtime. For example, if the PHY rate (or SR rate) of the Link 1 is 1/2 PHY rate of the Link 2, the number of data frames (e.g., MPDUs) on the Link 1 and Link 2 may by 1:2 to achieve the same PPDU duration. After the dispatch, the first MLD 510 may transmit the data frames to the second MLD 520 according to the dispatch.

FIG. 6 is a schematic diagram illustrating a data dispatch according to another embodiment of the invention. The first MLD 610 and the second MLD 620 can be respectively applied to the AP 110 and the communication apparatus 420. As shown in FIG. 6, the first MLD 610 may comprise a first AP module AP 1 and second AP module AP 2, and the second MLD 620 may comprise a first STA module STA 1 and a second STA module STA 2. The first AP module AP 1 and the first STA module STA 1 may correspond to Link 1, and the second AP module AP 2 and the second STA module STA 2 may correspond to Link 2. The Link 1 and the Link 2 may share the same BA window. As shown in FIG. 6, the first MLD 610 may transmit data frames (e.g., MPDUs) with the same TID (e.g., TID “n”) to the second MLD 620 through the Link 1 and the Link 2. In the embodiment, the first MLD 610 determines that the Link 1 wins the contention in the multi-link transmission, i.e., the backoff counter of the Link 1 reaches 0 first. Then, the first MLD 610 may determine or detect that the Link 1 the Link 2 maybe interfered by the OBSS traffic with the BSS color which is different from the data frames. Therefore, the first MLD 610 may determine to perform spatial reuse transmission on the Link 1 and Link 2. Then, the first MLD 610 may dispatch the data frames to the Link 1 and Link 2 based on the PHY rates and PERs of the Link 1 and Link 2 to achieve the closet FES airtime. That is, the partial data frames may be transmitted on the Link 1 and the remaining data frames may be transmitted on the Link 2 to achieve the closet FES airtime. For example, if the PHY rate (or SR rate) of the Link 1 is 1/2 PHY rate of the Link 2, the number of data frames (e.g., MPDUs) on the Link 1 and Link 2 may by 1:2 to achieve the same PPDU duration. After the dispatch, the first MLD 610 may transmit the data frames to the second MLD 620 according to the dispatch.

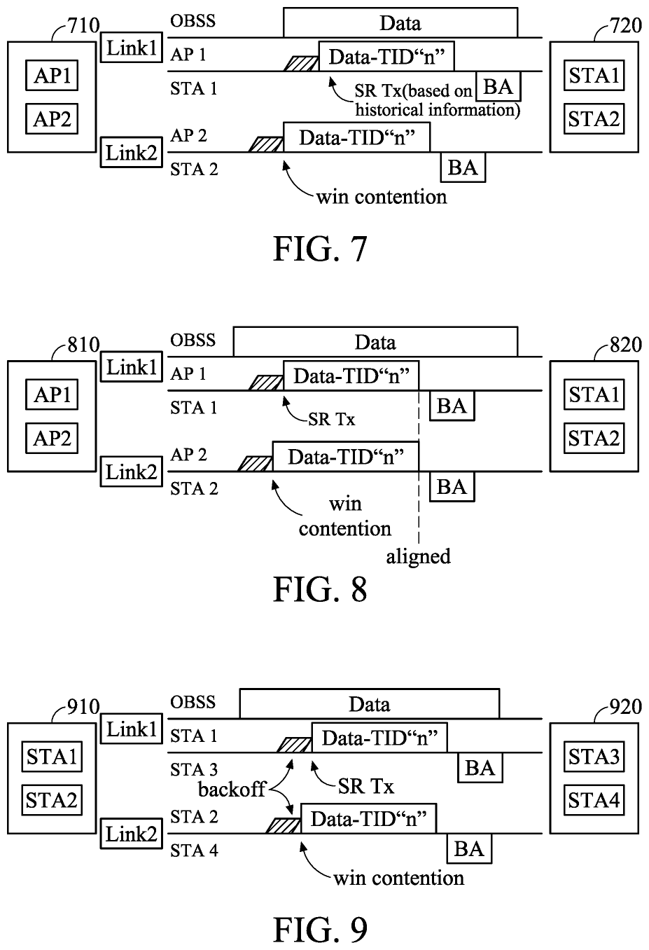

FIG. 7 is a schematic diagram illustrating a data dispatch according to another embodiment of the invention. The first MLD 710 and the second MLD 720 can be respectively applied to the AP 110 and the communication apparatus 120. As shown in FIG. 7, the first MLD 710 may comprise a first AP module AP 1 and a second AP module AP 2, and the second MLD 720 may comprise a first STA module STA 1 and second STA module STA 2. The first AP module AP 1 and the first STA module STA 1 may correspond to Link 1, and the second AP module AP 2 and the second STA module STA 2 may correspond to Link 2. The Link 1 and the Link 2 may share the same BA window. As shown in FIG. 7, the first MLD 710 may transmit data frames (e.g., MPDUs) with the same TID (e.g., TID “n”) to the second MLD 720 through the Link 1 and the Link 2. In the embodiment, the first MLD 710 determines that the Link 2 (idle link) wins the contention in the multi-link transmission, i.e., the backoff counter of the Link 2 reaches 0 first. Then, based on the historical information (e.g., historical overlapping record) corresponding to the Link 1, the first MLD 710 may determine that the Link 1 has higher probability to be interfered by the OBSS traffic. Therefore, the first MLD 710 may determine to perform spatial reuse transmission on the Link 1. Then, the first MLD 710 may dispatch the data frames to the Link 1 and Link 2 based on the PHY rates and PERs of the Link 1 and Link 2 to achieve the closet FES airtime. That is, the partial data frames may be transmitted on the Link 1 and the remaining data frames may be transmitted on the Link 2 to achieve the closet FES airtime. For example, if the PHY rate (or SR rate) of the Link 1 is 1/2 PHY rate of the Link 2, the number of data frames (e.g., MPDUs) on the Link 1 and Link 2 may by 1:2 to achieve the same PPDU duration. After the dispatch, the first MLD 710 may transmit the data frames to the second MLD 720 according to the dispatch.

FIG. 8 is a schematic diagram illustrating a data dispatch according to another embodiment of the invention. The first MLD 810 and the second MLD 820 can be respectively applied to the AP 110 and the communication apparatus 420. As shown in FIG. 8, the first MLD 810 may comprise a first AP module AP 1 and a second AP module AP 2, and the second MLD 820 may comprise a first STA module STA 1 and a second STA module STA 2. The first AP module AP 1 and the first STA module STA 1 may correspond to Link 1, and the second AP module AP 2 and the second STA module STA 2 may correspond to Link 2. The Link 1 and the Link 2 may share the same BA window. As shown in FIG. 8, the first MLD 810 may transmit data frames (e.g., MPDUs) with the same TID (e.g., TID “n”) to the second MLD 820 through the Link 1 and the Link 2. In the embodiment, the first MLD 810 determines that the Link 2 (idle link) wins the contention in the multi-link transmission, i.e., the backoff counter of the Link 2 reaches 0 first. Then, the first MLD 810 may determine or detect that the Link 1 maybe interfered by the OBSS traffic with the BSS color which is different from the data frames. Therefore, the first MLD 810 may determine to perform spatial reuse transmission on the Link 1. Then, the first MLD 810 may dispatch the data frames to the Link 1 and Link 2 based on the PHY rates and PERs of the Link 1 and Link 2 to achieve the closet FES airtime. That is, the partial data frames may be transmitted on the Link 1 and the remaining data frames may be transmitted on the Link 2 to achieve the closet FES airtime.

In addition, the first MLD 810 may further concern the backoff time of the Link 1 and Link 2 to dispatch the data frames to the Link 1 and Link 2. For example, it is assumed that the PHY rate (or SR rate) and the PERs of the Link 1 and the PHY rate of the Link 2 are the same and the total PPDU duration (i.e., the total length of the data frames (MPDUs)) for the Link 1 and Link 2 is 1000 microsecond (μs). When the backoff counter of the Link 2 reaches 0 and the remaining backoff time of the Link 1 is 4 slot time (e.g., 36 μs), the first MLD 810 may dispatch the data frames with 964 μs PPDU duration to the Link 1 and dispatch the data frames with 1036 μs PPDU duration to Link 2 to make the ends of the data frames transmitted on the Link 1 and Link 2 are aligned (as shown in FIG. 8). After the dispatch, the first MLD 810 may transmit the data frames to the second MLD 820 according to the dispatch.

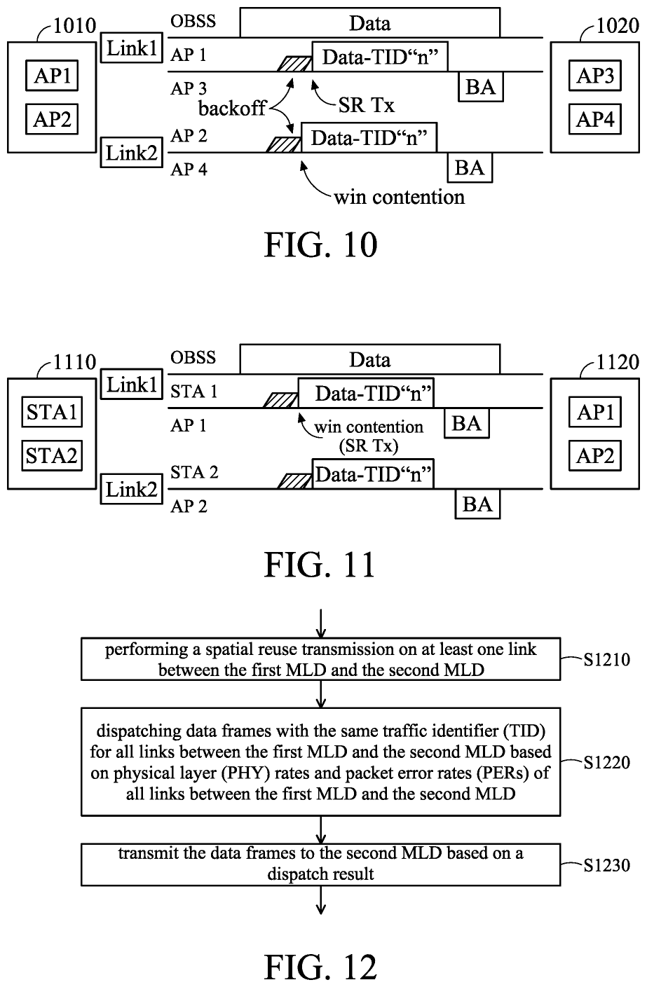

It should be noted that in FIG. 4˜FIG. 8, the first MLD is applied to the AP and the second MLD is applied to the communication apparatus (e.g., STA), but the invention should not be limited thereto. In other embodiments, the first MLD also can be applied to the communication apparatus (e.g., STA), and the second MLD also can be applied to the AP. The embodiments of FIG. 4˜FIG. 8 also can applied to the transmission from an AP to another AP, from a communication apparatus (e.g., STA) to another communication apparatus (e.g., STA), or from a communication apparatus (e.g., STA) to an AP. That is, the transmitting end in the embodiments of the invention can be an AP or a communication apparatus (e.g., STA), and the receiving end can be an AP or a communication apparatus (e.g., STA). For example, as shown in FIG. 9, the transmitting end (i.e., the first MLD 910) may be a communication apparatus (e.g., STA) and the receiving end (i.e., the second MLD 920) may be another communication apparatus (e.g., STA). In another example, as shown in FIG. 10, the transmitting end (i.e., the first MLD 1010) may be an AP and the receiving end (i.e., the second MLD 1020) may be another AP. In another example, as shown in FIG. 11, the transmitting end (i.e., the first MLD 1110) may be a communication apparatus (e.g., STA) and the receiving end (i.e., the second MLD 1120) may be an AP.

FIG. 12 is a flow chart illustrating a data transmission method according to an embodiment of the invention. The data transmission method can be applied to a multi-link operation between a first multi-link device (MLD) and a second MLD (e.g., applied to the wireless communication system 100). As shown in FIG. 12, in step S1210, the first MLD may perform a spatial reuse transmission on at least one link between the first MLD and the second MLD.

In step S1220, the first MLD may dispatch data frames with the same traffic identifier (TID) for all links between the first MLD and the second MLD based on the physical layer (PHY) rates and packet error rates (PERs) of all links between the first MLD and the second MLD.

In step S1230, the first MLD may transmit the data frames to the second MLD based on a dispatch result.

According to an embodiment of the invention, in the data transmission method, the first MLD may dispatch the data frames with the same TID for all links through one of the links. The link may win a contention and the link may be an idle link.

According to an embodiment of the invention, in the data transmission method, the first MLD may dispatch the data frames with the same TID for all links through one of the links. The link may win a contention and the spatial reuse transmission may be performed on the link.

According to an embodiment of the invention, in the data transmission method, the first MLD may dispatch the data frames with the same TID for all links through one of the links. The link may win a contention, and besides the link, the spatial reuse transmission may be performed on one or more other links.

According to an embodiment of the invention, in the data transmission method, the first MLD may dispatch the data frames with the same TID for all links further based the historical information through one of the links. The link may win a contention.

According to an embodiment of the invention, in the data transmission method, the first MLD may dispatch the data frames with the same TID for all links further based on the backoff time of a link through the link. The link may win a contention.

According to an embodiment of the invention, in the data transmission method, data lengths of data frames dispatched for different links are the same or different.

According to the data transmission method provided in the invention, the spatial reuse and the data dispatch for multi-link operation can be concerned at the same time for data transmission. Therefore, in the data transmission method provided in the invention, the airtime for data transmission will not be wasted, and better bandwidth efficiency can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission method, applied to a multi-link operation between a first multi-link device (MLD) and a second MLD, comprising:
performing, by a processor of the first MLD, a spatial reuse transmission on at least one link between the first MLD and the second MLD;
dispatching, by the processor, data frames with the same traffic identifier (TID) for all links between the first MLD and the second MLD based on physical layer (PHY) rates and packet error rates (PERs) of all links between the first MLD and the second MLD; and
transmit, by the processor, the data frames to the second MLD based on a dispatch result.

2. The data transmission method of claim 1, further comprising:
dispatching, by the processor, the data frames with the same TID for all links through a link of the links, wherein the link wins a contention and the link is an idle link.

3. The data transmission method of claim 1, further comprising:
dispatching, by the processor, the data frames with the same TID for all links through a link of the links, wherein the link wins a contention and the spatial reuse transmission is performed on the link.

4. The data transmission method of claim 1, further comprising:
dispatching, by the processor, the data frames with the same TID for all links through a link of the links, wherein the link wins a contention, and the spatial reuse transmission is performed on the link and one or more other links.

5. The data transmission method of claim 1, further comprising:
dispatching, by the processor, the data frames with the same TID for all links further based on historical information through a link of the links, wherein the link wins a contention.

6. The data transmission method of claim 1, further comprising:
dispatching, by the processor, the data frames with the same TID for all links further based on a backoff time of a link through the link of the links, wherein the link wins a contention.

7. The transmission method of claim 1, wherein data lengths of data frames dispatched for different links are the same or different.

8 The transmission method of claim 1, where first MLD is an access point (AP) or a station (STA), and second MLD is another AP or another STA.

9. An access point (AP) for a multi-link operation between the AP and a station (STA), comprising:
a transceiver, configured to perform wireless transmission and reception to and from the STA;
a processor, coupled to the transceiver, and performing operations comprising:
performing a spatial reuse transmission on at least one link between the AP and the STA; and
dispatching data frames with the same traffic identifier (TID) for all links between the AP and the STA based on physical layer (PHY) rates and packet error rates (PERs) of all links between the AP and the STA;
transmitting, via the transceiver, the data frames to the STA based on a dispatch result.

10. The AP of claim 9, wherein the processor further performs operations comprising:
dispatching the data frames with the same TID for all links through a link of the links, wherein the link wins a contention and the link is an idle link.

11. The AP of claim 9, wherein the processor further performs operations comprising:
dispatching the data frames with the same TID for all links through a link of the links, wherein the link wins a contention and the spatial reuse transmission is performed on the link.

12. The AP of claim 9, wherein the processor further performs operations comprising:
dispatching the data frames with the same TID for all links through a link of the links, wherein the link wins a contention, and the spatial reuse transmission is performed on the link and one or more other links.

13. The AP of claim 9, wherein the processor further performs operations comprising:
dispatching the data frames with the same TID for all links further based on historical information through a link of the links, wherein the link wins a contention.

14. The AP of claim 9, wherein the processor further performs operations comprising:
dispatching the data frames with the same TID for all links further based on a backoff time of a link through the link of the links, wherein the link wins a contention.

15. A station (STA) for a multi-link operation between an access point (AP) and the STA, comprising:
a transceiver, configured to perform wireless transmission and reception to and from the AP; and
a processor, coupled to the transceiver, and performing operations comprising:
receiving, via the transceiver, data frames with the same traffic identifier (TID) from the AP based on a dispatch result,
wherein a spatial reuse transmission is performed on at least one link between the AP and the STA, and
wherein the data frames are dispatched for all links between the AP and the STA based on physical layer (PHY) rates and packet error rates (PERs) of all links between the AP and the STA to determine the dispatch result.

16. The STA of claim 15, wherein the data frames with the same TID are dispatched for all links through a link of the links, and wherein the link wins a contention and the link is an idle link.

17. The STA of claim 15, wherein the data frames with the same TID are dispatched for all links through a link of the links, and wherein the link wins a contention and the spatial reuse transmission is performed on the link.

18. The STA of claim 15, wherein the data frames with the same TID are dispatched for all links through a link of the links, and wherein the link wins a contention, and besides the link, the spatial reuse transmission is performed on one or more other links.

19. The STA of claim 15, wherein the data frames with the same TID are dispatched for all links further based on historical information through a link of the links, and wherein the link wins a contention.

20. The STA of claim 15, wherein the data frames with the same TID are dispatched for all links further based on a backoff time of a link through the link of the links, and wherein the link wins a contention.
